(19) United States
(12) Patent Application Publication
(10) Pub. No.: US 2016/0189340 A1
(43) Pub. Date: Jun. 30, 2016

(54) ADJUSTING CONTENT ON AN INTERACTIVE DISPLAY TO USER PHYSICAL HEIGHT AND REACH

(71) Applicant: Lenovo Enterprise Solutions (Singapore) Pte. Ltd., Singapore (SG)

(72) Inventors: Gary D. Cudak, Wake Forest, NC (US); Lydia M. Do, Raleigh, NC (US); Christopher J. Hardee, Raleigh, NC (US); Adam Roberts, Moncure, NC (US)

(21) Appl. No.: 14/583,955

(22) Filed: Dec. 29, 2014

(51) Int. Cl. G06T 3/20; G06T 7/00; G06F 3/041

(52) U.S. Cl. CPC G06T 3/20; G06F 3/0416; G06T 7/004

(57) ABSTRACT

Methods and systems may provide for identifying a reference position on an interactive display, wherein the reference position is associated with a physical height and/or reach of a user. Additionally, previously drawn content on the interactive display may be identified and automatically moved to the reference position. In one example, a prompt is displayed adjacent to the reference position and a response to the prompt is received, wherein the previously drawn content is moved based on the response.

### BACKGROUND

Embodiments of the present invention generally relate to interactive displays. More particularly, embodiments relate to adjusting content on interactive displays to user physical height and reach.

An interactive plasma display (IPD) is a touch-based system that may be used to replace chalkboards and/or whiteboards in educational, corporate and courtroom settings. A conventional IPD may be attached to a vertical surface (e.g., wall), hung vertically from the ceiling, rested vertically on an easel, and so forth, wherein users of different heights may write content on the IPD. In some circumstances, previously drawn content may be positioned either too high or too low on the IPD for a subsequent user to reach comfortably.

### BRIEF SUMMARY

Embodiments may include a computer program product to adjust content height, the computer program product comprising a computer readable storage medium having program instructions embodied therewith, the program instructions executable by a computing device to cause the computing device to identify a reference position on an interactive display, wherein the reference position is to be associated with a physical height of a user, identify previously drawn content on the interactive display, and automatically move the previously drawn content to the reference position.

Embodiments may also include a method of adjusting content height, comprising identifying a reference position on an interactive display based on one or more of an eye level or a first writing gesture, wherein the reference position is associated with a physical height of a user, identifying previously drawn content on the interactive display, displaying a prompt adjacent to the reference position, and automatically moving the previously drawn content one or more of leftward, rightward, upward or downward to the reference position based on one or more of a response to the prompt or a second writing gesture.

Embodiments may include a computer program product to adjust content height, the computer program product comprising a computer readable storage medium having program instructions embodied therewith, the program instructions executable by a computing device to cause the computing device to identify a reference position on an interactive display based on one or more of an eye level or a first writing gesture, wherein the reference position is to be associated with a physical height of a user, identify previously drawn content on the interactive display, display a prompt adjacent to the reference position, and automatically move the previously drawn content one or more of leftward, rightward, upward or downward to the reference position based on one or more of a response to the prompt or a second writing gesture.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is an illustration of an example of an interactive display having previously drawn content automatically moved according to an embodiment;

FIG. 2 is a flowchart of an example of a method of adjusting content height according to an embodiment;

FIG. 3 is an illustration of an example of the use of a mini map to move previously drawn content according to an embodiment;

FIG. 4 is an illustration of an example of the use of a set of arrows to move previously drawn content according to an embodiment;

FIG. 5 is an illustration of an example of the use of the direction of a writing gesture to move previously drawn content according to an embodiment;

FIG. 6 is an illustration of an example of the use of a boundary of a writing gesture to move previously drawn content according to an embodiment; and

FIG. 7 is a block diagram of an example of an interactive display device according to an embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers, or functional equivalents thereof. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

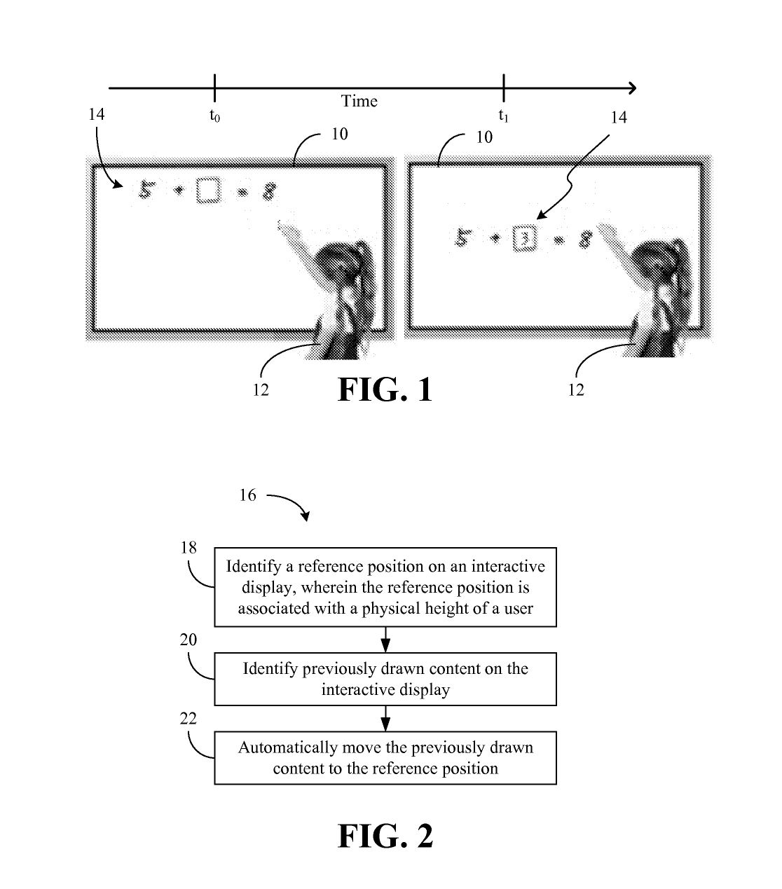

Turning now to FIG. 1, an interactive display 10 is shown. In the illustrated example, previously drawn content 14 is initially located at a relatively high position on the interactive display 10. The previously drawn content 14 may have been written by a relatively tall person or shifted to the illustrated position at a time prior to time t₀. Due to the shorter height and/or reach of the user 12, the previously drawn content 14 cannot be accessed comfortably by the user 12. Accordingly, the illustrated interactive display 10 automatically moves the previously drawn content 14 at time t₁ to a reference position associated with the physical height and/or reach of the user 12 at time t₀. Thus, the illustrated approach eliminates any need for a step stool or physically movable display in order for the user to modify the previously drawn content 14.

FIG. 2 shows a method 16 of adjusting content height. The method 16 may be implemented by an interactive display device such as, for example, the interactive display 10 (FIG. 1), already discussed. Illustrated processing block 18 provides for identifying a reference position on the interactive display, wherein the reference position is associated with a physical height and/or reach of a user. Block 18 may include, for example, using cameras or other sensors to detect the eye level of the user, capturing a writing gesture from the user and analyzing the writing gesture to infer an appropriate reference position, and so forth. The reference position may be one dimensional (e.g., vertical height) or two dimensional (e.g., vertical height and lateral position), depending on the circumstances (e.g., one user writing on the display versus multiple users writing on the display). Block 20 may identify previously drawn content on the interactive display, wherein the previously drawn content may be automatically moved to the reference position on the display device at block 22. As will be discussed in greater detail, block 22 may include the use of prompts and/or additional writing gestures to move the previously drawn content.

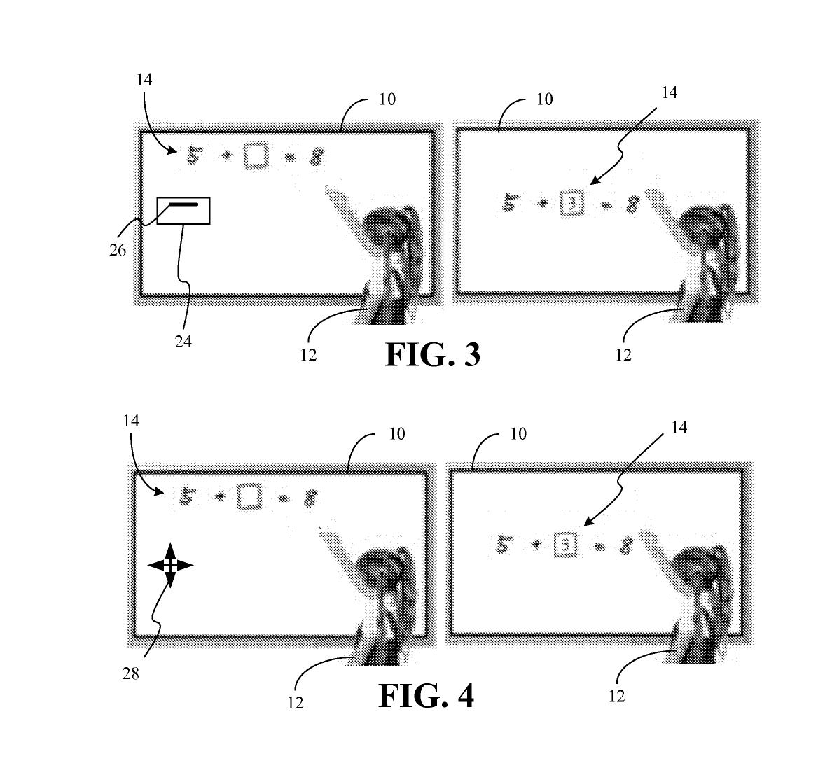

For example, FIG. 3 demonstrates that a mini map 24 or other legend may be displayed adjacent to the reference position as a prompt to the user 12. The mini map 24 may include a smaller version of all content written on the interactive display 10, wherein the selection of a compressed representation 26 of the previously drawn content 14 by the user 12 may result in the previously drawn content 14 being moved to the reference position associated with the physical height and/or reach of the user 12.

FIG. 4 demonstrates that one or more arrows 28 may be displayed adjacent to the reference position as a prompt to the user 12. The arrows 28 may point in multiple directions (e.g., leftward, rightward, upward, downward), wherein the selection of a particular direction by the user 12 may result in all content on the interactive display 10 being shifted in the selected direction (e.g., downward in the example shown) on the interactive display 10.

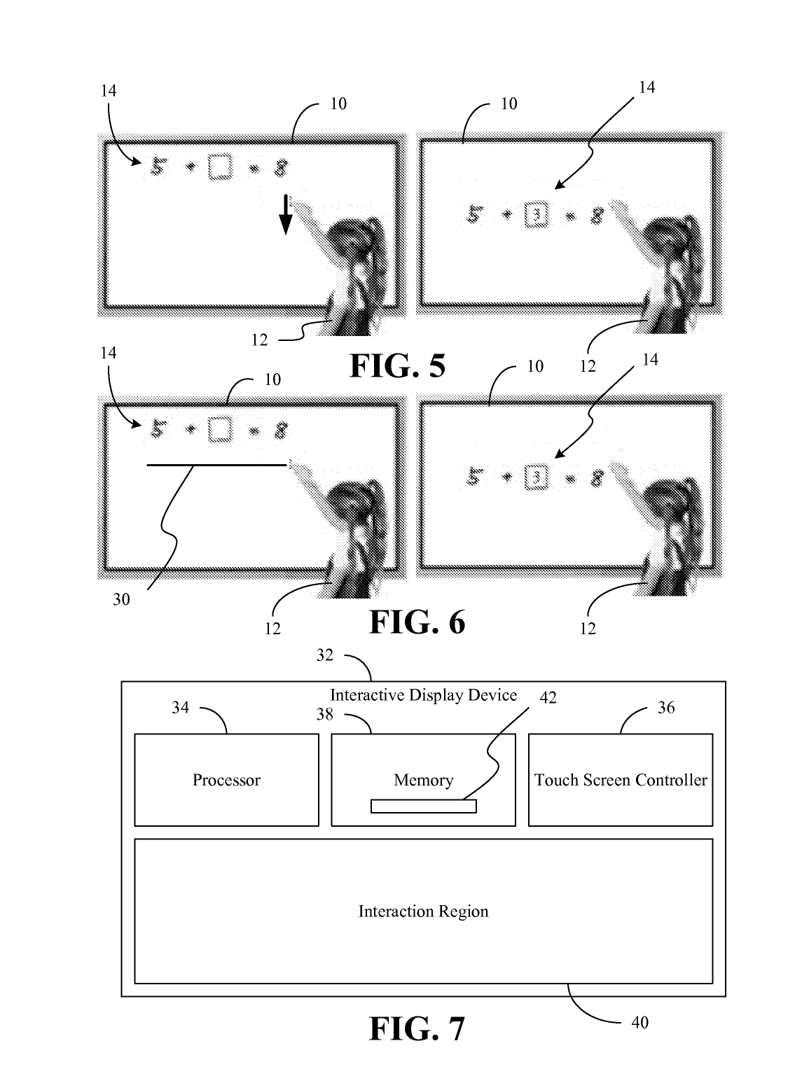

Additionally, FIG. 5 demonstrates that the direction of a writing gesture may be used to trigger the move of the previously drawn content 14 to the reference position. In the illustrated example, the user 12 makes a downward motion with the writing pen in order to direct the movement of the previously drawn content 14 downward to the reference position.

FIG. 6 demonstrates that a boundary of a writing gesture may be used to move the previously drawn content 14 to the reference position. In the illustrated example, the user 12 draws a horizontal line 30 to indicate that the previously drawn content 14 is to be moved beneath the vertical height boundary defined by the horizontal line 30. Other examples of determining when to move the previously drawn content 14 may also be used.

FIG. 7 shows an interactive display device 32 that may be readily substituted for the interactive display 10 (FIGS. 1 and 3-6), already discussed. The interactive display device 32 may be an IPD other interactive display. In the illustrated example, the device 32 includes a processor 34, a touch screen controller 36, memory 38 (e.g., read only memory/ROM, random access memory/RAM, flash memory, or other suitable computer readable storage medium) and an interaction region 40. The memory 38 may have program instructions 42 embodied therewith, wherein the program instructions 42 are executable by the processor 34 and/or touch screen controller 36 to perform a method such as, for example, the method 16 (FIG. 2). Thus, for example, execution of the instructions 42 may cause the interactive display device 32 to identify a reference position on the interaction region 40, wherein the reference position is to be associated with a physical height of a user, identify previously drawn content on the interaction region 40 and automatically move the previously drawn content to the reference position. Accordingly, the interactive display device 32 may be a computer program product that includes a computer readable storage medium such as, for example, the memory 38 having program instructions embodied therewith, as well as a whiteboard or other display device such as, for example, the interaction region 40.

Techniques described herein may therefore enable interactive displays to be shared by different users having different reach capabilities without involving the use of ladders/step stools or movable displays. Accordingly, educational, corporate, courtroom and other settings may benefit from the automatic content adjustment techniques described herein.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A method of adjusting content height, comprising:
identifying a reference position on an interactive display based on one or more of an eye level or a first writing gesture, wherein the reference position is associated with a physical height of a user;
identifying previously drawn content on the interactive display;
displaying a prompt adjacent to the reference position; and
automatically moving the previously drawn content one or more of leftward, rightward, upward or downward to the reference position based on one or more of a response to the prompt or a second writing gesture.

2. The method of claim 1, wherein the prompt includes a mini map.

3. The method of claim 1, wherein the prompt includes one or more arrows.

4. The method of claim 1, wherein the previously drawn content is moved based on a direction of the second writing gesture.

5. The method of claim 1, wherein the previously drawn content is moved based on a boundary of the second writing gesture.

6. A computer program product to adjust content height, the computer program product comprising a computer readable storage medium having program instructions embodied therewith, the program instructions executable by a computing device to cause the computing device to:
identify a reference position on an interactive display based on one or more of an eye level or a first writing gesture, wherein the reference position is to be associated with a physical height of a user;
identify previously drawn content on the interactive display;
display a prompt adjacent to the reference position; and
automatically move the previously drawn content one or more of leftward, rightward, upward or downward to the reference position based on one or more of a response to the prompt or a second writing gesture.

7. The computer program product of claim 6, wherein the prompt is to include a mini map.

8. The computer program product of claim 6, wherein the prompt is to include one or more arrows.

9. The computer program product of claim 6, wherein the previously drawn content is to be moved based on a direction of the second writing gesture.

10. The computer program product of claim 6, wherein the previously drawn content is to be moved based on a boundary of the second writing gesture.

11. A computer program product to adjust content height, the computer program product comprising a computer readable storage medium having program instructions embodied therewith, the program instructions executable by a computing device to cause the computing device to:
identify a reference position on an interactive display, wherein the reference position is to be associated with a physical height of a user;
identify previously drawn content on the interactive display; and
automatically move the previously drawn content to the reference position.

12. The computer program product of claim 11, wherein the program instructions are further executable by a computing device to:
display a prompt adjacent to the reference position; and
receive a response to the prompt, wherein the previously drawn content is moved based on the response.

13. The computer program product of claim 12, wherein the prompt is to include a mini map.

14. The computer program product of claim 12, wherein the prompt is to include one or more arrows.

15. The computer program product of claim 11, wherein the program instructions are further executable by a computing device to detect a writing gesture, wherein the previously drawn content is to be moved based on the writing gesture.

16. The computer program product of claim 15, wherein the previously drawn content is to be moved based on a direction of the writing gesture.

17. The computer program product of claim 15, wherein the previously drawn content is to be moved based on a boundary of the writing gesture.

18. The computer program product of claim 11, further including a display device, wherein the previously drawn content is to be moved one or more of leftward, rightward, upward or downward to the reference position on the display device.

19. The computer program product of claim 11, wherein the reference position is to be identified based on an eye level.

20. The computer program product of claim 11, wherein the reference position is to be identified based on a writing gesture.
